(19) United States
(12) Patent Application Publication
(10) Pub. No.: US 2025/0110761 A1
(43) Pub. Date: Apr. 3, 2025

(54) REAL TIME RELOCATION OF OVERLAY COMPONENTS IN A DIGITAL ADOPTION PLATFORM

(71) Applicant: Whatfix Private Limited, Bangalore (IN)

(72) Inventors: Maruthi Priya Kanyaka Vara Kumar NAMBURU, Bengalaru (IN); Gourav H. DHELARIA, Bangalore (IN)

(21) Appl. No.: 18/480,420

(22) Filed: Oct. 3, 2023

(51) Int. Cl. G06F 9/451; G06F 3/0481; G06F 3/0485; G06F 8/38; G06F 16/957

(52) U.S. Cl. CPC G06F 9/453; G06F 3/0481; G06F 3/0485; G06F 8/38; G06F 16/9577

(57) ABSTRACT

Provided herein are systems and methods for creating and relocating overlay elements in real time within a digital adoption platform (DAP) used in conjunction with an underlying computer application. In some embodiments, a method includes loading a page of the underlying application, loading the DAP, using the DAP to identify selected elements that are visible components of the user interface of the underlying application, create and display overlay elements over the user interface, each of the plurality of overlay elements being associated with and displayed visibly adjacent to a corresponding selected element, but placed in an independent location in the code from the corresponding selected element, detect changes that visibly affect the display of the selected elements, and change the display of the overlay elements based on changes detected so that the overlay elements visibly match the changes to the selected elements.

### INCORPORATION BY REFERENCE

All publications and patent applications mentioned in this specification are incorporated herein by reference in their entirety to the same extent as if each individual publication or patent application was specifically and individually indicated to be incorporated by reference.

### BACKGROUND

There are many ways for end users to learn how to use a particular software application. Increasingly, many methods take the form of digital guidance, such as a Help Section built into the software application or links to online help content. Examples of online help or learning content include knowledge bases, answers to Frequently Asked Questions (FAQs), tutorials, videos, PDF documents, etc. “Walkthroughs” may be provided in either scenario, wherein the user is walked through a particular task or process step by step in the actual software application.

All of the digital guidance content may be provided to a user in one place, organized with a table of contents and or an index, and it may be searchable using keywords. Still, it may be overwhelming to a user to be provided with so much content at once. It is desirable to only provide a limited amount of digital guidance content to a user at any one time, focused on what they may currently need help with and not showing them content that is not currently relevant to what they are doing. Accordingly, a limited number of hyperlinks or other pathways to relevant content may be provided in various sections or segments of the software, and these links may change depending on the task being performed by the end user and or their location in the software application.

Guidance can also be provided in the form of certain components such as question mark icons and additional help symbols, which provide additional information. Generally, if a developer is providing digital guidance content for their own application, components are added adjacent to the element they relate to as a sibling or a child of that element. Since the added component is within the same parent component, it gets scrolled with the element automatically by the browser. However, if the digital guidance content is added as an overlay platform, the developer or user does not have the flexibility to attach the overlays to the same parent component since it will change the overall look and feel of the website and will change the way web accessibility tools work. This creates issues such as the added components not scrolling with the elements they relate to.

What is needed and is not provided by the prior art are improved systems and methods for providing digital guidance content, while reducing the burden being placed on the creators of the content. The innovations described herein solve these unmet needs and provide additional advantages.

### SUMMARY OF THE DISCLOSURE

According to aspects of the present disclosure, systems and methods for creating and relocating overlay elements in real time within a digital adoption platform (DAP) used in conjunction with an underlying computer application are provided. In some embodiments, a method of providing and relocating overlay elements in real time within a digital adoption platform used in conjunction with an underlying computer application includes the steps of loading a page of an underlying application and loading a digital adoption program (DAP). The DAP is configured to provide a user with guidance in using the underlying application. The DAP is then used to identify a plurality of selected elements, wherein the selected elements are visible components of a user interface of the underlying application. The DAP is further used to create and display a plurality of overlay elements over the user interface. Each of the plurality of overlay elements is associated with and displayed visibly adjacent to a corresponding one of the plurality of selected elements but is placed in an independent location in the code (such as an independent location in a Document Object Model (DOM) tree) from the corresponding selected element. The DAP is further used to detect changes that visibly affect the display of the selected elements. The DAP is further used to change the display of one or more of the plurality of overlay elements based on changes to the selected elements detected in the detecting step so that the overlay elements visibly match the changes to the selected elements.

In some embodiments, the change to the display of the one or more overlay elements includes one or more of hiding, unhiding, moving and scaling the overlay element. The detect changes step may include checking whether one of the selected elements is visible, and if not, then removing the associated overlay element in the change the display step. In some embodiments, the detect changes step includes checking whether one of the selected elements is overlapped by another element on the page, and if so, then hiding the associated overlay element in the change the display step until such time as the overlapping element fades away or disappears. The detect changes step may include checking whether one of the selected elements is still attached to the page, and if not, then removing the associated overlay element completely in the change the display step. In some embodiments, the detect changes step includes checking a position of one of the selected elements, and if the selected element has moved from an initial position, then obtaining a new position and moving the overlay element to the new position in the change the display step.

In some embodiments, the overlay element is placed in the same window as the selected element. If the selected element is within an inline frame (iframe) and the size of the iframe is too small to accommodate the overlay element without inducing a scroll bar, the overlay element may be placed in a topframe window. The coordinates of the selected element may be calculated from a top and left corner of a window containing the selected element. In some embodiments, the overlay element is placed with Cascading Style Sheets (CSS) coding with absolute positioning using the coordinates calculated for the selected element.

In some embodiments, messages are passed from an inline frame (iframe) containing the selected element to a frame containing the overlay element, and all the messages are sent using HTML5 postMessage. A top window containing the overlay element may process the message and take appropriate action for displaying the overlay element.

In some embodiments, the detect changes step is configured to detect movement of at least one of the selected elements. The movement detection may be based on checking for changes in the page or based on periodic timers. The method of movement detection may be determined by whether a number of selected elements exceeds a predetermined number. In some embodiments, the predetermined number is between 2 and 50. The movement detection may be executed every 500 milliseconds to observe changes to the selected elements, and change the position of the overlay elements accordingly with a periodic relocation algorithm. In some embodiments, the periodic relocation algorithm is run at each of a plurality of inline frame (iframe) levels.

In some embodiments, the DAP further includes a mutation observer interface configured to watch for changes being made to a Document Object Model (DOM) tree. The DAP may further include a scroll listener added on to at least one of the selected elements and configured to detect whenever the selected element is scrolled.

### BRIEF DESCRIPTION OF THE DRAWINGS

The novel features of the disclosure are set forth with particularity in the claims that follow. A better understanding of the features and advantages of the present disclosure will be obtained by reference to the following detailed description that sets forth illustrative embodiments, in which the principles of the disclosure are utilized, and the accompanying drawings of which:

FIG. 1 is a diagram showing an example of a digital guidance platform configuration for providing digital guidance in an underlying computer application.

FIG. 2 is a diagram showing exemplary configurations of how the digital guidance platform of FIG. 1 interfaces with an underlying computer application.

FIGS. 3A-3I are a series of partial screenshots showing exemplary functionality of a content authoring module/editor.

FIGS. 4A and 4B are screenshots showing examples of different lists of walkthroughs that are displayed by a content playback module depending on the location of an end user in an underlying software application.

FIGS. 5A-5I are a series of partial screenshots showing examples of types of segmentation criteria.

FIG. 6 is a screenshot of an exemplary underlying base application showing two examples of selected elements and two examples of corresponding overlay elements.

FIG. 7 is a screenshot of the exemplary underlying base application of FIG. 6 showing an example of a selected element and its corresponding overlay element being hidden.

FIG. 8 is a screenshot of the exemplary underlying base application of FIG. 6 showing an example of a selected element and its corresponding overlay element being moved due to page scrolling.

FIG. 9 is a diagram schematically showing an exemplary system configured to track selected elements, and in response, change the associated overlay elements.

FIG. 10 is a flow chart summarizing steps of an exemplary method of providing and relocating overlay elements in real time.

### DETAILED DESCRIPTION

Described herein are apparatuses (e.g., systems, computing device readable media, devices, etc.) and methods for an improved digital guidance platform. The innovative platform changes the way application support and learning content is consumed. In some embodiments, this is accomplished by providing contextual and interactive walkthroughs inside software applications at the time a task is being performed (i.e., providing real-time guidance to users.) Examples of software applications that the platform may be used with include Salesforce®, Oracle CRM®, Microsoft Dynamics®, Success Factors®, SharePoint® and other applications. In some embodiments, the innovative platform may take the form of a simple web browser extension. Developers of a software application may use the extension to provide guided navigation to users of the software application so that the users can quickly learn how to use the application. The users' training and or support experience can be enhanced with walkthroughs, smart pop-ups and tool-tips provided by the platform. These platform tools may be configured to show up based on a particular user's role and current location in the software application. The innovative platform may be used with enterprise application software (such as the software applications mentioned above), custom application software (such as created by an IT department for a company's internal use), and end user software. Depending on the application, the innovative platform may be the only training and support program for the application, or it may be used in conjunction with a training and support program native to the application.

In some embodiments, the innovative platform supports an end user through their entire life cycle with a software application. This may include new user onboarding, continuous training, self-serve contextual support, assistance with data field validation, and application change management. The platform technology may include omni-channel integrations (such as integrating with knowledge systems, bases and repositories), workflow automation, in-place answers, workflow analytics, and content authoring.

Referring to FIG. 1, an exemplary digital guidance platform 100 is depicted. It may include a content authoring module 110 (also referred to as an editor) and a content playback module 112, as shown. In this exemplary embodiment, the content authoring module 110 allows a content author to create digital guidance for end users of an underlying software application. Once this content is created and saved, it may be accessed or “played back” using the content playback module 112. In some implementations, the content authoring module 110 and the content playback module 112 are combined and provided to a content author in a single software package. In use, the software package may reside on a content author's computer, and or may reside on a server in “the cloud” and be offered as Software as a Service (SaaS.) In other implementations, content authoring module 110 and a content playback module 112 may be separately deployed. For example, one of the modules may take the form of a simple web browser extension as previously mentioned, and the other module may be downloaded to a content author's computer.

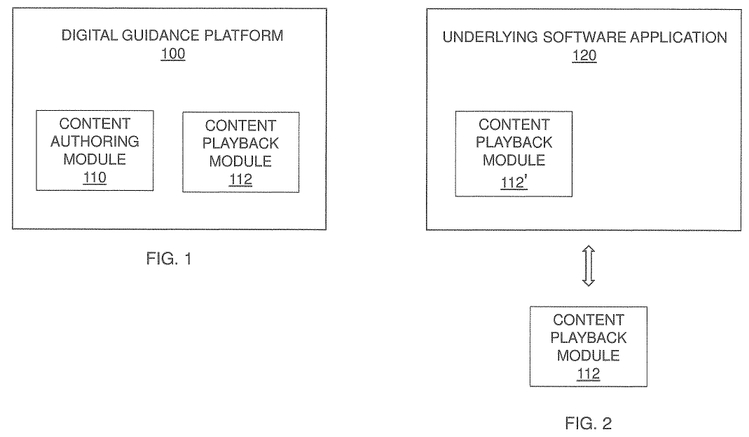

Referring to FIG. 2, exemplary content playback configurations are depicted. In some implementations, content playback module 112 is a standalone system that is accessed by an end user from within an underlying software application 120. For example, an underlying software application 120, such as Salesforce©, may be provided with links to access content playback module 112, which is located on a server in the cloud. In some implementations, content playback module 112′ may be integrated within the underlying software application 112′. In either of these exemplary configurations, the end user is able to access the digital guidance content from content playback module 112 or 112′ while using a feature of underlying software application 120 with which the content is associated. In some implementations, both an integrated content playback module 112′ and an external module 112 are available to the end user.

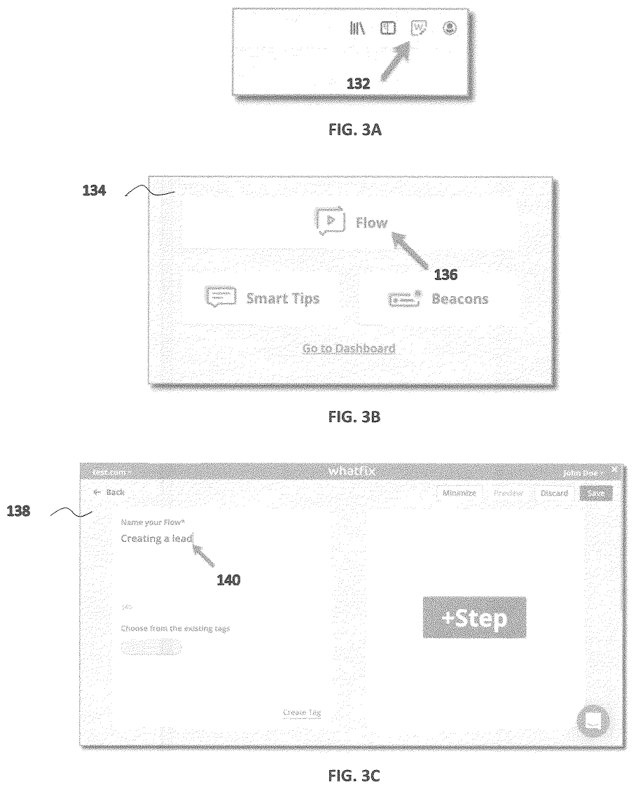

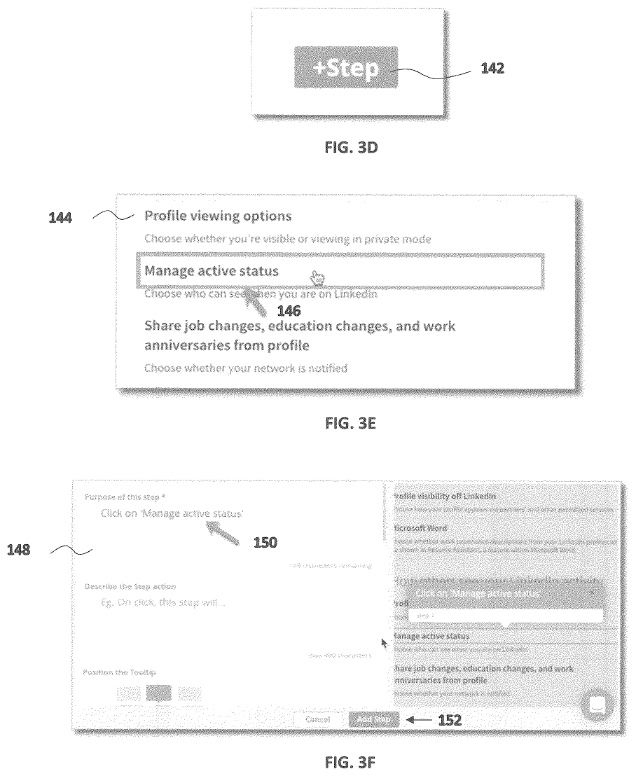

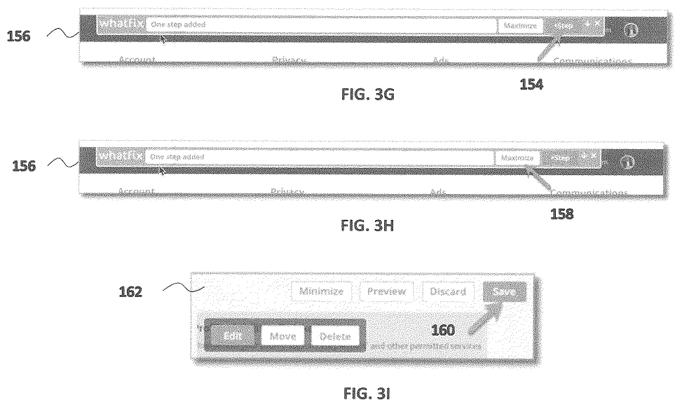

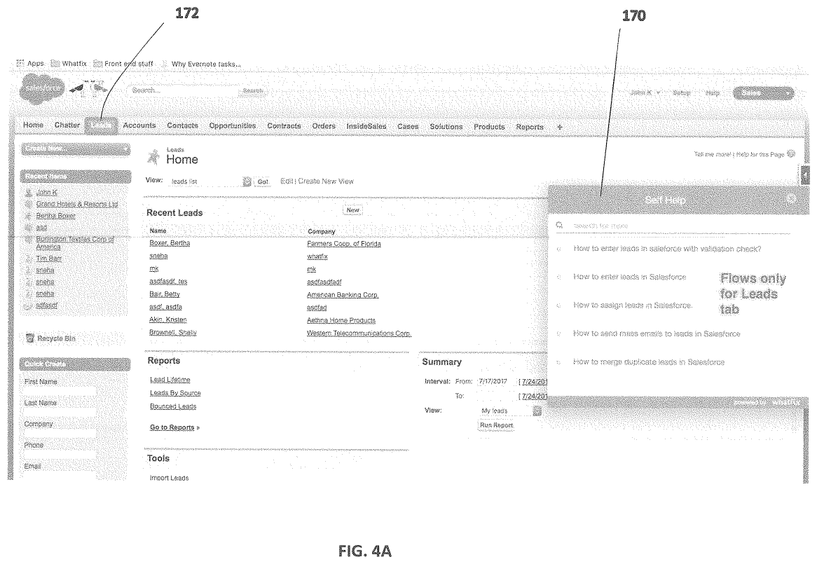

Referring to FIGS. 3A-3I, exemplary functionality of content authoring module/editor 110 will be described in relation to the exemplary partial screenshots in the figures. In this exemplary embodiment, the patent applicant's company name “whatfix” is used as the name of digital guidance platform 100. The exemplary functionality includes the ability to create a “walkthrough”, which will walk an end user of underlying software application 120 through each sequential step of a particular task in application 120 when the walkthrough is played back. In some implementations, the walkthrough can proceed either one step at a time, waiting at the end of each step for the end user to advance the walkthrough to the next step. Alternatively, the walkthrough can proceed automatically, running through all of the steps without stopping (unless paused by the user.) Additionally, the walkthrough can provide the end result of the task that the walkthrough is teaching. For example, a walkthrough can show an end user each step needed to determine the number of open sales leads that have not been contacted, and at the end of the walkthrough the actual number is provided to the end user. Referring first to FIG. 3A, the creation of a walkthrough begins by the author logging in to the underlying application where the author wants to create content, and then launching the previously described content authoring module/editor 110 by clicking icon 132.

Once the editor launches, it displays window 134 as shown in FIG. 3B. Window 134 includes three buttons labeled Flow, Smart Tips and Beacons. The Flow button is for creating walkthroughs, the Smart Tips button is for creating content associated with data field validation, and the Beacons button is for creating content associated with software application change management. In this example the author clicks the Flow button 136.

Clicking Flow button 136 opens window 138, as shown in FIG. 3C. Here the author can name the Flow or walkthrough as they want it to be displayed to an end user. In this example, the Flow is named “Creating a lead”, as shown by arrow 140.

The author then clicks the +Step button 142, as shown in FIG. 3D. In some embodiments, the pointer icon changes (such as from an arrow to a hand), as shown in screen 144 of FIG. 3E, to indicate that the editor is waiting for the author to select a step of the sequence that the end user is to be guided through. The author then clicks the desired element on the page of the underlying software application that the end user will need to select. In this example, the end user will be guided to select the Manage Active Status button 146 on screen 144 during playback of the walkthrough, so the Flow author clicks button 146 at this time.

After the Flow author clicks the desired element 146, the editor module displays screen 148 as shown in FIG. 3F with automatically generated action text 150 describing the particular step. The Flow author may then review, edit and or add text or other information associated with the step. The author may also select other parameters regarding how this step of the walkthrough will be played back, such as the position of the Tooltip on the screen, or accept some or all of the default settings. Once the parameters of this step are in order, the author then clicks the Add Step button 152.

To capture the next step in the sequence, the Flow author then navigates to where in the underlying software application the author wants to start the next step. The author then clicks the +Step button 154 in the editor toolbar 156, as shown in FIG. 3G. The pointer icon again changes to indicate that the editor is waiting for the author to select another step of the sequence, as previously described in reference to FIG. 3E. The author then repeats the intervening actions described above for each step that is to be added to the Flow sequence. When all the steps have been captured, the author clicks the Maximize button 158 on the editor toolbar 156, as shown in FIG. 3H, and then clicks the Save button 160 after window 162 opens, as shown in FIG. 3I.

Before various walkthroughs are made available to end users of the underlying software application, segmentation or mapping may be used to associate each walkthrough with a particular page or part of the underlying software. Segmentation helps content authors display only walkthroughs that are relevant to end users when they are on a particular page. Segmentation, as the name implies, provides a way of targeting walkthroughs to specific users on “widgets” like Self-help and Task List on previously described content playback module 112. Segments can be defined through various conditions and rules. In some embodiments, a segment can be built to filter walkthroughs as per user login, the contents of a Uniform Resource Locator (URL), elements on the screen, and/or a mix of other criteria. For example, segments may be used to display walkthroughs based on a particular group of users' logins, a current tab an end user is on, visual elements on pages of the underlying software and/or other variable(s) defined by the walkthrough author.

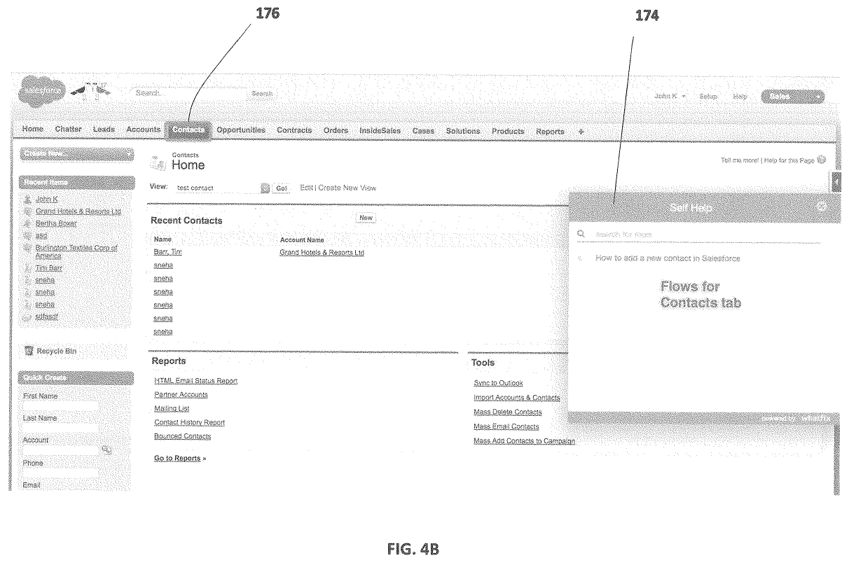

In one embodiment, a page of the underlying software application may have two different tabs, for example: Leads and Contacts. Using segments, different walkthroughs can be displayed depending on which tab the end user navigates to. Rather than seeing a long list of help content, the end user only sees contextual content that is relevant to the particular page and tab currently being used. FIG. 4A shows an example of a list of walkthroughs 170 that is displayed by content playback module 112 when the end user has navigated to the Leads tab 172 of an underlying Salesforce application and clicked on Self Help. FIG. 4B shows an example of a different list of walkthroughs 174 that is displayed by module 112 when the end user has navigated to the Contacts tab 176.

Segments can be created through a simple selection of walkthroughs and visibility rules provided in the editor module 110. To segment walkthroughs, an author can manually select all the necessary flows/walkthroughs to display on a particular page of the application. Segmentation can be set up based on tags as well. Tags can be as simple as a user group or the page/module name. Segmentation of flows can be set up through single or multiple tags. In some embodiments, the editor module 110 can perform segmentation on the basis of visual elements found in the application. The editor can segment flows based on visual elements present or absent on various pages of the underlying application.

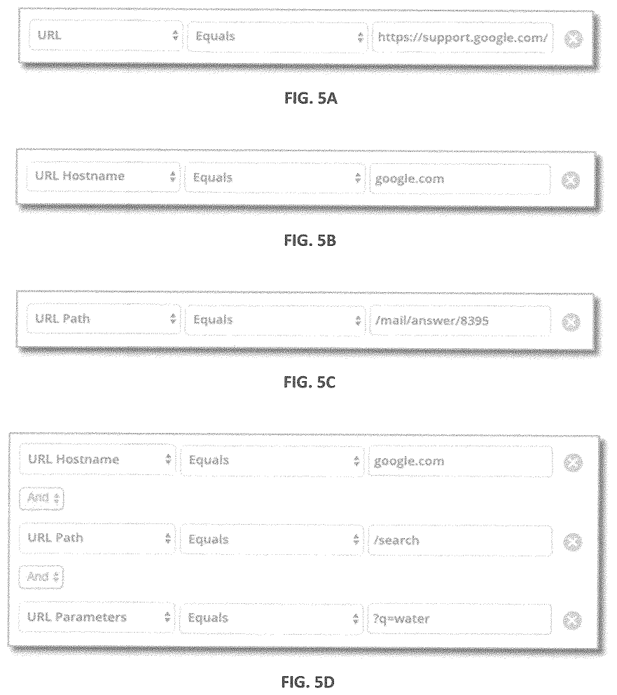

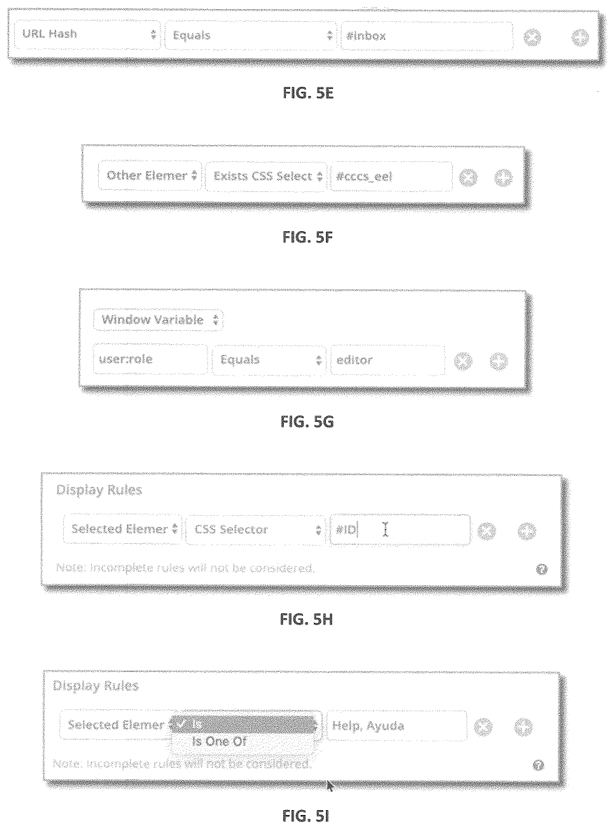

Referring to FIGS. 5A-5I, specific examples of types of segmentation criteria that may be used are provided.

Referring to FIG. 5A, a Uniform Resource Locator (URL) may be used to segment flows. In some embodiments, any part of the URL may be specified as a visibility rule. For example, the URL Hostname, path, parameter, etc. may be specified using this criterion.

Referring to FIG. 5B, a URL Hostname may be used to segment flows. In some implementations, a content author may want to uniquely identify a page using the domain name and can use this condition. The URL Hostname is the first part of any URL. For example, if the author wished to display the tip only if the end user is on google.com, she can add a condition as shown in the screenshot of FIG. 5B.

Referring to FIG. 5C, a URL Path may be used to segment flows. The website path name is what is listed between a domain name and the parameters or hashes. For example, if the website URL is //support.google.com/mail/answer/8395?hl=en&ref_topic=3394219, then the pathname is /mail/answer/8395. This condition may be specified as shown in FIG. 5C.

Referring to FIG. 5D, a URL Parameter may be used to segment flows. If an author wishes to identify a web page using the parameters on the URL, this condition may be used. For example, if a tip is to be shown to a user only when the search phrase has “water” in Google, this can be set up as shown in FIG. 5D. In this example, three conditions need to be met: 1) the page must be google.com (URL Hostname); 2) the pathname is/search (URL Path); and 3) the query parameter is ?q=water.

Referring to FIG. 5E, a URL Hash may be used to segment flows. In particular, a page may be identified using the hash value of the URL using this condition. Hashes are usually present in Single page applications made using AngularJs or ReactJs. Typically, there are no page refreshes but only Hash changes.

Referring to FIG. 5F, Other Elements may be used to segment flows. For example, if a content author wants to identify a page based on the presence of a particular element (other than the one selected by the author for the flow) on the web page, this condition can be used. In some embodiments, the values passed to this condition are Cascading Style Sheets (CSS) selectors, such as #ID, .class or Jquery. Cascading Style Sheets is a stylesheet language used to describe the presentation of a document written in HTML or XML. CSS describes how elements should be rendered on screen or on other media. Note that in some implementations, use of this condition to segment flows can slow down the underlying application. Further information on the use of CSS selectors may be found on the internet, such as at https://developer.mozilla.org/en-US/docs/Web/CSS/CSS_Selectors.

Referring to FIG. 5G, a Window Variable may be used to segment flows. In some implementations, a value of a particular JavaScript global variable is used to identify conditions for showing tooltips. For example, an option to check “user.role=‘admin’” may be provided to set this condition. This option may also be to perform comparisons, such as using the following criteria: Greater than; Less than; Date Greater than; or Date Less than.

Referring to FIG. 5H, an Element CSS Selector/JQuery may be used to segment flows. In some implementations, the application uses unique IDs for some elements on the page. This option may be used when the element is selected from a list of options. For example, a drop-down menu. This lets an author provide their own CSS selector identifier for the element. Sample values include: #ID_ELEMENT; CLASSNAME; input[title=“Search” ]; and $(“#ID”).

Referring to FIG. 5I, an Element Text may be used to segment flows. In some implementations, this is the text that is displayed on the Element selector that is described above in reference to FIG. 5H. If an application supports multiple languages, the option “is one of” may be chosen and the name added with a comma (,) as a delimiter.

The exemplary segmentation criteria described above with reference to FIGS. 5A-5I may be used to manually segment various flows/walkthroughs and other content. According to aspects of the disclosure, editor module 110 may also be configured to automatically segment the content. In some embodiments, the content is automatically segmented as it is created, with no additional steps required by the content author. This may be referred to as “intelligent segmentation” (IS). In some embodiments, intelligent segmentation eliminates the need to create multiple segments (manually) to display relevant content contextually to different audiences on an underlying application. For example, if an underlying application has five pages and two user roles, traditionally ten segments would need to be created to ensure that each kind of user sees only the relevant topics on each of the five pages. But when intelligent segmentation is enabled and content is being created, editor module 110 can automatically determine which content is to be shown on which page. In some embodiment, editor module 110 can do this based on where the walkthrough was created and certain other pre-defined criterion. The content author need not do any additional configuration as more content is created.

Intelligent segmentation can also ensure that if an end user is not on the first screen of a walkthrough, playback of the walkthrough starts from the most relevant page that the user is on. For example, the walkthrough that the user is launching may have 10 steps. If the user is already in step 3 on the application and then decides to launch the walkthrough, IS ensures that the walkthrough starts from step 4 and not from the earlier steps that the user has already completed.

Currently when the users open self-help, all the users see the same set of contents as designed by the content creators. But the needs of individual users vary and hence, they must spend time seeking out the particular content they need. Instead, the contents can be personalized for every user based on a recommendation engine as described herein, so that users find the content they need upfront when they open self-help. Users also find self-help more useful and their engagement with self-help goes up. This results in self-help being used more often and not for longer period of time, thereby improving user engagement.

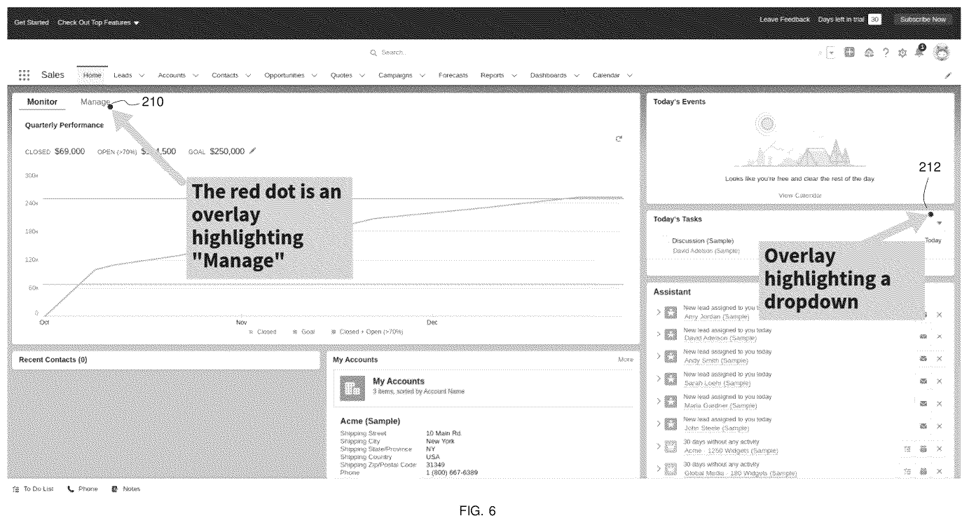

According to aspects of the present disclosure, systems and methods are provided for coordinating user interface elements of the previously described digital guidance content or Digital Adoption Platform (DAP) with user interface elements of the underlying base application. Referring to FIGS. 6-10, an exemplary embodiment of a system implemented according to aspects of the present disclosure will be described.

The exemplary Digital Adoption Platform (DAP) described in more detail below includes an overlay layer configured to display user interface (UI) components, such as the previously described smart tips and beacons. These components, referred to herein as “overlay elements”), are displayed by the overlay layer over an underlying base application user interface. In order to serve their function, these components are expected to be latched onto a “selected element” within the base application. Whenever a user scrolls the page, or due to certain changes in the page, a given selected element may move from its initial position. When this occurs, it is desirable to have the associated overlay element move with the selected element.

Generally, when developers are creating their own DAP within their own base application, these DAP components are added adjacent to the selected element as a sibling or a child element. Since this is within the same parent component, the sibling or child element gets scrolled with the parent element automatically by the browser. However, when a DAP is created by a developer separately from the underlying base application, the developer does not have the flexibility to attach the overlays to the same parent component since it will change the overall look and feel of the underlying application or website and will change the way web accessibility tools work. For example, if a developer is creating a DAP on platforms such as Salesforce etc., there is limited scope for modification of DOM tree to attach the DAP components adjacent to the respective elements, since they don't have access to the source code. In such cases, prior art solutions require that an external DAP be used.

In light of the above, the inventive DAP layer disclosed herein solves the following problems (in addition to others):
1) The user interface of the base application can be constantly changing—the selected element may not be visible at the time of a page load and may become visible later, or a selected element which is visible initially may become hidden later.
2) The position of the selected element may change as the user scrolls, or the page is resized or if other elements are shown/hidden in the page.
3) The selected element may be contained in an inline frame (iframe), and possibly nested to many levels. In this situation, detection of the selected element may need specific handling.
   In each of the above situations, the inventive system can show or hide the overlay element, resize it, and or change its position accordingly. The inventive system can put overlay icons onto any third-party application that look and behave as if they were inserted by the original application. The system essentially tracks all of the changes on the original element and applies the relevant changes to the icons, as described in more detail below.

Referring first to FIG. 6, a screenshot of an exemplary underlying base application is provided, along with two examples of overlay elements. The first example is a red dot 210 shown just below and to the right of the word “Manage”, which is a tab label in the underlying application. Here, dot 210 is a DAP overlay element that serves to highlight the Manage tab when guiding DAP users on the use of the tab. As mentioned above, dot 210 is referred to herein as an “overlay element”, and the Manage tab is referred to as a “selected element”, to which the overlay element is “latched”. The second example of an overlay element in FIG. 6 is another red dot 212 shown just above and to the right of dropdown menu button (i.e., the selected element.)

In other implementations, the overlay element can be another color or colors, another shape, a word or words, symbol(s), icon(s), and or other element or component. The selected element can be anything in the underlying program that a developer wants to highlight.

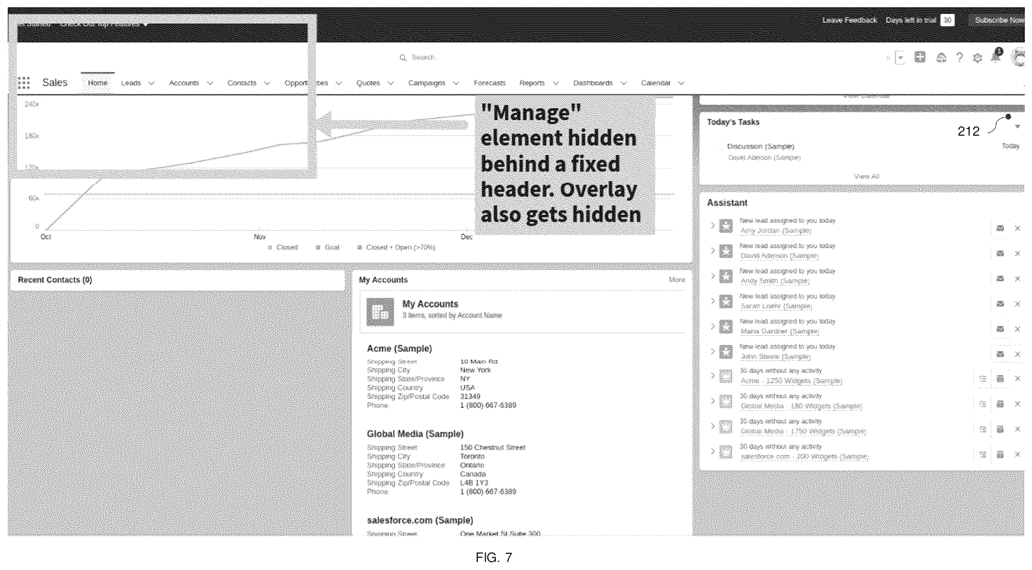

Referring next to FIG. 7, another screenshot of the exemplary underlying base application of FIG. 6 is provided. In this view, the selected element Manage tab is hidden behind a fixed header, such as when the page or window has been scrolled, or other change has occurred in the underlying program. As shown, the overlay element associated with the hidden selected element also gets hidden by the DAP layer, as will be subsequently described. However, in this example, the other selected element (i.e., the dropdown menu button) is not hidden, so the overlay element 212 associated with it remains visible.

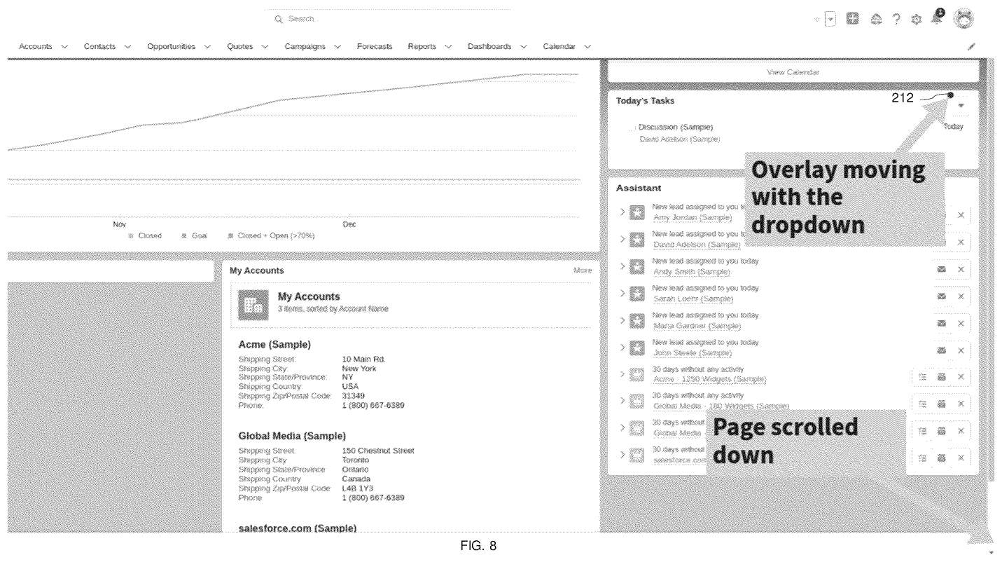

Referring now to FIG. 8, another screenshot of the exemplary underlying base application of FIG. 6 is provided. In this view, the selected element Manage tab and its associated overlay element remain hidden and the other selected element (i.e., the dropdown menu button) and the overlay element 212 associated with it remain visible. However, in this view, the page has been scrolled down, moving the dropdown menu button upward. As shown, the DAP layer has moved the overlay element 212 upward also, so that it remains in the same position relative to the dropdown menu button (i.e., is latched to the button).

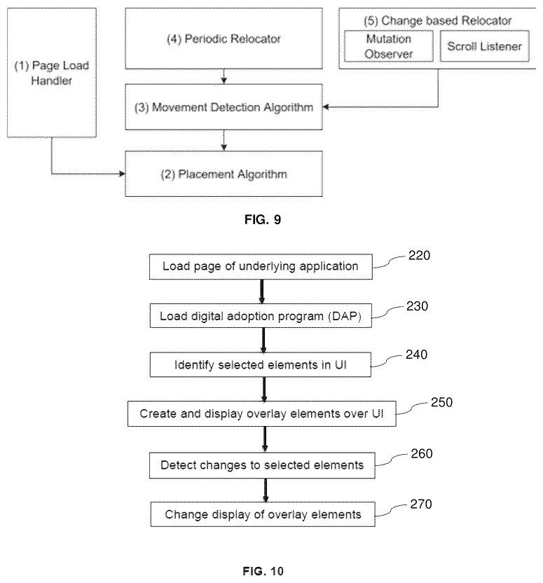

Referring to FIG. 9, an exemplary system is shown that is configured to track the appearance, disappearance and change in position and size of selected elements, and in response, show, hide, move and or scale associated overlay elements accordingly. In this exemplary embodiment, the primary mechanism for accomplishing this is to listen for mutation events (i.e., detect the addition and removal of elements), and scroll/resize events (i.e., detect changes in position and or size). The functional blocks of the exemplary system are described below.

Two variations may be used to find changes in the page and relocate elements accordingly. When the number of selected elements is low (such as 2, 5, 10, 20, 50 or fewer, in some implementations), it may be optimal to observe changes in the elements periodically. This first approach is described below in section (4), Periodic Relocator. When there are many selected elements in the page (such as more than 2, 5, 10, 20 or 50, in some implementations), it may be optimal to look for all mutations and scroll events in the complete web page and relocate the overlay elements accordingly. This second approach is described below in section (5), Change based relocator.

The blocks described below may have different implementations depending on where the selected element is found, such as in either the top window or in an inline frame (iframe), possibly nested to many levels. Whenever there are specific differences, these are described in the respective sections below.

### (1) Page Load Handler

During operation of the exemplary system, a page of the underlying base application loads. Then the DAP loads. A finder algorithm of the DAP identifies the selected elements. Only a subset of selected elements may be visible on the initial page load. The finder algorithm captures a variety of attributes related to the element such as its tag name, height, width, parent element, etc. While identifying the selected elements, the algorithm tries to match these attributes to find the right element. For all the selected elements found in the page, the Page Load Handler module (1) triggers the Placement Algorithm module (2). Based on the number of selected elements, as described above, either the Periodic Relocator module (4) is initialized, or the Change-based Relocator module (5) is initialized.

### (2) Placement Algorithm

In the exemplary system, the overlay element may be placed in the same window (topframe or iframe) as the selected element. But the overlay element is not inserted next to the selected element, but rather in an independent location so that it does not change the overall look and feel of the application. In other words, the overlay elements are not placed as a direct child or sibling of the selected element. They are instead inserted into the body of the html document. If the selected element is within an iframe and the size of the iframe is too small to accommodate the overlay element without inducing a scroll bar, the overlay element may be placed in the topframe window.

(2.1)

Placing the overlay element when the selected element is in top window or if it is in an iframe which is large enough to accommodate the overlay element:
The coordinates of the selected element may be calculated from the top and left corner of the containing window (top window or iframe).
The overlay element may be placed with Cascading Style Sheets (CSS) coding with absolute positioning using these coordinates.
   (2.2)

Placing the overlay element when the selected element is in an iframe which is too small to accommodate the overlay element:
The coordinates of the selected element may be calculated from the top and left corner of the iframe.
These coordinates may be sent to the parent of the iframe. This adds the offset of the child iframe from its top and left edges.
This process may be continued until the topframe is reached. The final coordinates may be used to place the overlay element in the top window using CSS absolute positioning. But visually it may be placed just beside the selected element.
All the messages passed from iframe to the containing/parent frames may be done using HTML5 postMessage. The top window processes this message and takes the appropriate action of displaying the overlay element.

### (3) Movement Detection Algorithm

Based on changes in the page (e.g., mutations), or based on timers, the overlay element may have to be shown, hidden, moved and or scaled. The method below may be used for this purpose, which can be called up in later sections when the decision to move is made. The method:
Checks if the selected element is visible (e.g., height and width of the element aren't equal to zero). If it is not visible, then the overlay component is removed.
Checks if the selected element is overlapped by some popup or any other element on the page. If it is overlapped, then the overlay component is hidden until such time as the overlapping element fades away/disappears. In some implementations, this is done by modeling each element as a rectangular box in the DOM tree. The center of the rectangle may be calculated as the midpoint of the diagonal end points of the rectangle. There is a method “elementFromPoint,” available on the Document Object. This returns the topmost element at the specified co-ordinates. This method may be invoked using the coordinates of the center of the rectangle. If the element returned from this method is the same as the selected element, then it is not considered overlapped. If a different element is returned, the selected element is considered overlapped.
Checks if the selected element is still attached to the page. If it is not, then the overlay component is removed completely.
Checks the position of the selected element. If the element has moved from the initial position, the new position is obtained and the overlay component is moved accordingly.

### (4) Periodic Relocator

Once the page is loaded, the selected element may disappear or change its position due to user actions. Accordingly, the Movement Detection Algorithm may be executed periodically (such as every 500 milliseconds) to observe the changes to selected elements and change the position of the overlay elements accordingly. The periodic relocation algorithm may be run at each iframe level.

### (5) Change Based Relocator

(5.1) Mutation/Scroll Based Movement when the Selected Element is in Top Window

The steps below may be performed if the selected element is in the top window.
During the initial page load, if any of the selected elements are found in the page, display the corresponding overlay element (as described in the “Placement Algorithm (2)” section above).
The inventive system can add a MutationObserver on the document. The MutationObserver is an interface that provides the ability to watch for changes being made to the Document Object Model (DOM) tree. When there are changes on the page, the MutationObserver gets notified. In some embodiments, the MutationObserver is a built-in API that browsers provide to get notified when an element of interest undergoes certain changes. For each mutation on the page, the following may be done:
   Find the selected elements which were not found earlier. If a selected element is found, display the corresponding overlay element, as described in the “Placement Algorithm (2)” section above.
   Execute the Movement Detection Algorithm (3) for all the currently added overlay elements.
The inventive system can also add a Scroll Listener on the selected element. Anytime the element is scrolled, the Scroll Listener gets notified. Browsers provide an in-built way to listen for scroll events on an element. Once this is subscribed to, a notification is provided whenever the element is scrolled. For each scroll notification, execute the Movement Detection Algorithm (3) for all the currently added overlay elements.
   (5.2) Mutation/Scroll Based Movement when Selected Element is in Iframe Windows

The steps below may be performed if the selected element is in an iframe window.
When the page loads, a search is initiated from the top document. The top document may contain multiple iframes, and the system tries to find the best possible match which internally may contain the selected element. Once the best match is found in the top document, a search is conducted for the next subsequent best match which could contain the selected element. This process continues until the last level of the iframe which contains the selected element is reached. The system then chooses what it believes is the closest match. While selecting the element, the depth of the iframe containing the selected element can also be captured. This helps the system narrow down the search.
Once the selected element is found, a MutationObserver and a ScrollListener may be added at the innermost iframe level.
If the selected element is not found, it is added to a list of not found elements within that iframe.
For each mutation in the iframe, the following may be done:
   Find the selected elements which were not found earlier within that iframe. If a selected element is found, display the corresponding overlay element (as described above in “Placement Algorithm (2)” section) and remove that selected element from the not found list.
   Execute the Movement Detection Algorithm (3) as described above for all the currently added overlay elements.
For each scroll of selected elements in the iframe, execute the Movement Detection Algorithm (3) for all the currently added overlay elements.
Whenever a new iframe is inserted into the page, try to find all the not found digital guidance tips, starting from the top window.

Referring to FIG. 10, steps of an exemplary method of providing and relocating overlay elements in real time are shown. The exemplary method starts with step 220 in which a page of an underlying application is loaded. In step 230, a digital adoption program (DAP) is loaded. As previously described, the DAP is configured to provide a user with guidance in using the underlying application. The DAP is used to perform the remaining steps 240-270 of the method.

In step 240, the DAP identifies a plurality of selected elements. As previously described, the selected elements are visible components of the user interface of the underlying application. A plurality of overlay elements is created and displayed over the user interface in step 250. Each of the plurality of overlay elements is associated with and displayed visibly adjacent to a corresponding one of the plurality of selected elements. However, each overlay element is placed in an independent location in the code from the corresponding selected element.

In step 260, the DAP detects changes that visibly affect the display of the selected elements. The DAP then changes the display of one or more of the plurality of overlay elements in step 270. These changes to the display of the overlay elements are based on the changes detected in the detecting step 260 so that the overlay elements visibly match the changes to the selected elements.

In some embodiments, fewer or additional steps to those described herein may be utilized, and/or the steps may be performed in a different order.

Various alternatives, modifications, and equivalents may be used in lieu of the above components. Additionally, the techniques described here may be implemented in hardware or software, or a combination of the two. The techniques may be implemented in computer programs executing on programmable computers that each includes a processor, a storage medium readable by the processor (including volatile and nonvolatile memory and/or storage elements), and suitable input and output devices. Program code may be applied to data entered using an input device to perform the functions described and to generate output information. The output information may be applied to one or more output devices.

Each program may be implemented in a high-level procedural or object-oriented programming language to operate in conjunction with a computer system. However, the programs may be implemented in assembly or machine language, if desired. In any case, the language may be a compiled or interpreted language.

Each such computer program can be stored on a storage medium or device (e.g., CD-ROM, hard disk or magnetic diskette) that is readable by a general or special purpose programmable computer for configuring and operating the computer when the storage medium or device is read by the computer to perform the procedures described. The system also may be implemented as a computer-readable storage medium, configured with a computer program, where the storage medium so configured causes a computer to operate in a specific and predefined manner.

Thus, any of the methods (including user interfaces) described herein may be implemented as software, hardware or firmware, and may be described as a non-transitory computer-readable storage medium storing a set of instructions capable of being executed by a processor (e.g., computer, tablet, smartphone, etc.), that when executed by the processor causes the processor to control or perform any of the steps, including but not limited to: displaying, communicating with the user, analyzing, modifying parameters (including timing, frequency, intensity, etc.), determining, alerting, or the like.

While exemplary embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. Numerous different combinations of embodiments described herein are possible, and such combinations are considered part of the present disclosure. In addition, all features discussed in connection with any one embodiment herein can be readily adapted for use in other embodiments herein. It is intended that the following claims define the scope of the invention and that methods and structures within the scope of these claims and their equivalents be covered thereby.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached, or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Terminology used herein is for the purpose of describing particular embodiments only and is not intended to be limiting of the disclosure. For example, as used herein, the singular forms “a”, “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items and may be abbreviated as “/”.

Spatially relative terms, such as “under”, “below”, “lower”, “over”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal” and the like are used herein for the purpose of explanation only unless specifically indicated otherwise.

Although the terms “first” and “second” may be used herein to describe various features/elements (including steps), these features/elements should not be limited by these terms, unless the context indicates otherwise. These terms may be used to distinguish one feature/element from another feature/element. Thus, a first feature/element discussed below could be termed a second feature/element, and similarly, a second feature/element discussed below could be termed a first feature/element without departing from the teachings of the present disclosure.

Throughout this specification and the claims which follow, unless the context requires otherwise, the word “comprise”, and variations such as “comprises” and “comprising” means various components can be co-jointly employed in the methods and articles (e.g., compositions and apparatuses including device and methods). For example, the term “comprising” will be understood to imply the inclusion of any stated elements or steps but not the exclusion of any other elements or steps.

In general, any of the apparatuses and/or methods described herein should be understood to be inclusive, but all or a sub-set of the components and/or steps may alternatively be exclusive, and may be expressed as “consisting of” or alternatively “consisting essentially of” the various components, steps, sub-components or sub-steps.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical values given herein should also be understood to include about or approximately that value, unless the context indicates otherwise. For example, if the value “10” is disclosed, then “about 10” is also disclosed. Any numerical range recited herein is intended to include all sub-ranges subsumed therein. It is also understood that when a value is disclosed that “less than or equal to” the value, “greater than or equal to the value” and possible ranges between values are also disclosed, as appropriately understood by the skilled artisan. For example, if the value “X” is disclosed the “less than or equal to X” as well as “greater than or equal to X” (e.g., where X is a numerical value) is also disclosed. It is also understood that the throughout the application, data is provided in a number of different formats, and that this data, represents endpoints and starting points, and ranges for any combination of the data points. For example, if a particular data point “10” and a particular data point “15” are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

Although various illustrative embodiments are described above, any of a number of changes may be made to various embodiments without departing from the scope of the invention as described by the claims. For example, the order in which various described method steps are performed may often be changed in alternative embodiments, and in other alternative embodiments one or more method steps may be skipped altogether. Optional features of various device and system embodiments may be included in some embodiments and not in others. Therefore, the foregoing description is provided primarily for exemplary purposes and should not be interpreted to limit the scope of the invention as it is set forth in the claims. When a feature is described as optional, that does not necessarily mean that other features not described as optional are required.

The examples and illustrations included herein show, by way of illustration and not of limitation, specific embodiments in which the subject matter may be practiced. As mentioned, other embodiments may be utilized and derived therefrom, such that structural and logical substitutions and changes may be made without departing from the scope of this disclosure. Such embodiments of the inventive subject matter may be referred to herein individually or collectively by the term “invention” merely for convenience and without intending to voluntarily limit the scope of this application to any single invention or inventive concept, if more than one is, in fact, disclosed. Thus, although specific embodiments have been illustrated and described herein, any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A method of providing and relocating overlay elements in real time within a digital adoption platform used in conjunction with an underlying computer application, the method comprising the steps of:
loading a page of an underlying application;
loading a digital adoption program (DAP) which is configured to provide a user with guidance in using the underlying application;
using the DAP to:
identify a plurality of selected elements, wherein the selected elements are visible components of a user interface of the underlying application;
create and display a plurality of overlay elements over the user interface, each of the plurality of overlay elements being associated with and displayed visibly adjacent to a corresponding one of the plurality of selected elements, but placed in an independent location in the code from the corresponding selected element;
detect changes that visibly affect the display of the selected elements; and
change the display of one or more of the plurality of overlay elements based on changes detected in the detecting step so that the overlay elements visibly match the changes to the selected elements.

2. The method of claim 1, wherein the change to the display of the one or more overlay elements comprises one or more of hiding, unhiding, moving and scaling the overly element.

3. The method of claim 1, wherein the detect changes step comprises checking whether one of the selected elements is visible, and if not, then removing the associated overlay element in the change the display step.

4. The method of claim 1, wherein the detect changes step comprises checking whether one of the selected elements is overlapped by another element on the page, and if so, then hiding the associated overlay element in the change the display step until such time as the overlapping element fades away or disappears.

5. The method of claim 1, wherein the detect changes step comprises checking whether one of the selected elements is still attached to the page, and if not, then removing the associated overlay element completely in the change the display step.

6. The method of claim 1, wherein the detect changes step comprises checking a position of one of the selected elements, and if the selected element has moved from an initial position, then obtaining a new position and moving the overlay element to the new position in the change the display step.

7. The method of claim 1, wherein the overlay element is placed in the same window as the selected element.

8. The method of claim 1, wherein if the selected element is within an inline frame (iframe) and the size of the iframe is too small to accommodate the overlay element without inducing a scroll bar, the overlay element is placed in a topframe window

9. The method of claim 1, wherein coordinates of the selected element may be calculated from a top and left corner of a window containing the selected element.

10. The method of claim 9, wherein the overlay element is placed with Cascading Style Sheets (CSS) coding with absolute positioning using the coordinates calculated for the selected element.

11. The method of claim 1, wherein messages are passed from an inline frame (iframe) containing the selected element to a frame containing the overlay element, and wherein all the messages are sent using HTML5 postMessage.

12. The method of claim 11, wherein a top window processes the message and takes appropriate action for displaying the overlay element.

13. The method of claim 1, wherein the detect changes step is configured to detect movement of at least one of the selected elements.

14. The method of claim 13, wherein the movement detection is based on checking for changes in the page or based on periodic timers.

15. The method of claim 14, wherein a method of movement detection is determined by whether a number of selected elements exceeds a predetermined number.

16. The method of claim 15, wherein the predetermined number is between 1 and 50.

17. The method of claim 14, wherein the movement detection is executed every 500 milliseconds to observe changes to the selected elements, and change the position of the overlay elements accordingly with a periodic relocation algorithm.

18. The method of claim 17, wherein the periodic relocation algorithm is run at each of a plurality of inline frame (iframe) levels.

19. The method of claim 1, wherein the DAP further comprises a mutation observer interface configured to watch for changes being made to a Document Object Model (DOM) tree.

20. The method of claim 1, wherein the DAP further comprises a scroll listener added on to at least one of the selected elements and configured to detect whenever the selected element is scrolled.
